(19) United States
(12) Patent Application Publication
(10) Pub. No.: US 2018/0330063 A1
(43) Pub. Date: Nov. 15, 2018

(54) System for establishment of doctor mobile number privacy and effective communication between doctor and patient

(71) Applicants: Maruthi Viswanathan, Bangalore (IN); RxPrism Health Systems Private Limited, Bangalore (IN)

(72) Inventor: Maruthi Viswanathan, Bangalore (IN)

(21) Appl. No.: 15/652,041

(22) Filed: Jul. 17, 2017

(30) Foreign Application Priority Data
May 11, 2017 (IN) 201741016495

(51) Int. Cl. G06F 19/00

(52) U.S. Cl. CPC G06F 19/3425; G06F 19/328

(57) ABSTRACT

The present invention provides a system for establishing effective communication between doctor and patient. The system (100) comprises a registration engine (102) through which both doctor and patient register themselves with the system using smartphone (101). After registration, a DPN (Doctor's Private Number) is generated for doctor which can be shared with their patients. The patient can contact doctor using DPN or send an SMS (Short Message Service) to the system using SMS service engine (107). A telephonic conference is set up between doctor and patient using telephone conference call engine (103). A call engine (104) processes the call between doctor and patient. The payment can be done by the patient using a payment processing engine (105). The doctor is notified about the patient's interest to talk to him through push notification using notification engine (106).

### TECHNICAL FIELD OF THE INVENTION

The present invention relates to a doctor's telephone-call routing system for providing effective communication between doctor and patient using a smartphone and fully automated teleconference solution thereby ensuring doctor's mobile number privacy and increase patients' access to all doctors across the globe.

### BACKGROUND OF THE INVENTION

Generally, doctor appointments are as per first come first serve not based on patient's health criticality. This leads to unnecessary clinical congestion by patients with very simple problem or just came for lab report review, etc. This makes the patients who are critically ill not meet the doctor in time. Various systems have been suggested for establishing communication between a doctor and a patient in case of any trivial problem. In the recent years, many medical communication systems have been developed to establish effective communication between a doctor and a patient. Generally the communication between a doctor and a patient is carried out by calling on the doctor's mobile number. Patients seek free consultation over the phone for trivial problems during odd hours. They also pass on their doctor's mobile numbers to their friends and relatives, and sometimes even to medical representatives. Once a doctor shares his or her private mobile number with a patient, the doctor loses control over who will call him or her. This leads to compromise to their privacy and lose their personal time as well.

Various systems and methods have been disclosed in the prior art that provide alternate methods for direct communication between a doctor and a patient. The present system involves the use of mobile system interface which needs to be installed in both doctor and patient's smartphone. The doctor and the patient then needs to register their mobile number with the system interface and system will enable telephone conference in order to setup an effective communication in case of any trivial problems, reviewing lab reports, counseling sessions, second opinions, etc so that the patient doesn't need to visit doctor's office personally. The doctor's privacy is also maintained as their mobile number is not disclosed and their personal time is saved to a great extent to review patients in clinic who are critically ill.

Various types of medical systems and methods to establish effective communication between the doctor and the patient are known in the prior art. The US Patent document US20120290638 A1 describes a method for initiating messaging and communication services with physicians using a medical communication system. In the cited document, the system comprises of one or more servers configured to receive a contact request from a requestor through at least one of the one or more communication devices wherein the contact request comprises of a physician identifier identifying a selected physician from one or more physicians presented. The servers further comprises of one or more processors, memory devices and communication devices such as network interfaces through which machine readable codes stored on a machine readable medium, such as a physical memory device can be executed by the servers to provide the functionality of the medical communication system. The medical communication system disclosed in this document also encompasses various other hardware like client devices or other computing devices to interact with the system. The medical communication system has components in geographically remote locations. Such system and method enhances the flow of information to and from physicians and may provide tracking and recording services, such as for the purpose of keeping accurate and timely medical records but are not feasible for use in case of medical urgencies faced by the patient. Doctor's privacy is compromised as his or her mobile number gets disclosed by the patient to others. Patient has to visit doctor's office for any trivial problem which is a major drawback solved by the present invention as it ensures that patient don't have to make clinical visits to doctor for such trivial problems.

The United States Patent document US20160335399 A1 describes a system and method for a patient to initiate and complete a voice enabled, computerized, symptom-based medical history, at the time the patient is concerned about a medical problem. In the cited document, the invention describes a system by which any patient can use a mobile computer device such as a smartphone, to initiate and complete a voice-driven, interactive, logic-based, medical history questionnaire for any current medical complaint. Once the medical history questionnaire is ready, it is automatically sent to the patient's physician. At the time the physician calls a patient who has already taken a medical history, the physician will have at his disposal the medical history report and access to patient's data held in the physician's EHR (Electronic Health Record). The physician can have access to the patient PHR (Personal Health Record) too which may contain relevant data that was acquired by medical applications used with the smartphone and could be more recent data that the physician might want to see. Access would be granted optionally by the patient at the time of patient registration. Furthermore, the physician can have access to most recent data on the patients smartphone, which has been inputted via a sensor or non-sensor based application, and not moved to the patients PHR (Personal Health Record) or the patient could run the sensor-based application while the physician is on the physician's smartphone, which has direct data communication access via an Internet or cellular connection to the patient's smartphone and both have the same application such that the physician could monitor the patient in real time by means of application software.

The claimed systems and methods consume a lot of time for patients as they have to personally make clinical visit to the hospital even for trivial problems. Moreover the claimed systems and methods do not ensure mobile number privacy of the doctor as it can be accessed easily by any person.

Hence, there is a need for a system and method to establish an effective communication between a doctor and a patient in case of any trivial problem faced by the patient so that the patient can easily communicate and get an instant recommendation for management of his or her medical problem avoiding unnecessary frequent hospital visits. More particularly, the system or method must ensure mobile number privacy of the doctor.

### SUMMARY OF THE INVENTION

The present invention overcomes the drawbacks in the prior art and provides a system or method to establish effective communication between a doctor and a patient. The system comprises of various engines or servers which perform various functions associated with communication required between the doctor and the patient. The doctor registers with his or her mobile number in the system through Registration Engine. Once the doctor is registered with the system, a DPN (Doctor's Private Number) is generated which is a unique number that doctor can share with his or her patients. The patient also registers with his or her mobile number in the system along with the payment card details. Doctor can opt to receive call from patient or not by one click, either “Go Online” or “Go Offline”. The doctor can also enable option to receive “Emergency Call” from patient even if he or she is offline. Doctor configures his or her call fees as per call duration in the system for both normal call and emergency call. Patient dials the DPN of the doctor of his or her choice placing request to talk to particular doctor. If the doctor is “Online”, system will start processing the patient's request to talk to particular doctor. In case the doctor is “Offline”, a push notification or SMS (Short Message Service) reminder is send to doctor about the patient's interest to talk to him or her through Notification Engine. After viewing the notification if the doctor goes online, another push notification or SMS is sent to patient that doctor is now ready to receive calls and patient may dial DPN to talk and system will start processing the call request using Call Engine. While placing the call request, patient can also attach photos or include additional persons in the call by adding their mobile numbers. The system will start processing the call request by firstly making a call to doctor and then to the patient or vice versa or to both simultaneously and put them in a private telephone conference using Telephone Conference Engine. If doctor is busy with another patient call, system will place other patient in waiting list assigning a token number. Once the other patient's call gets over system will automatically start processing next call request from waiting patient as per their token number. If there is a need to talk to doctor immediately, waiting Patient can also opt for priority call with additional fees payment to by-pass the waiting queue and talk to doctor immediately. During telephone discussion, if the doctor or patient drops off from the conference call because of any mobile network or connectivity issue, the system will again redial and onboard them. The conference call is considered as complete if both doctor and patient disconnects the call or after a particular fixed call duration. For example—15 minutes. Once the call gets completed, the system will automatically charge the patient from his or her e-wallet or payment card or any other online payment instrument as per call duration multiplied by particular doctor's call fee and service charges. The Payment Processing Engine facilitates the processing of payment through Auto-debit, as the charges will be automatically deducted from patient payment instrument (card/wallet etc). The patient can also make call request to the system through SMS, by just messaging DPN number to particular mobile number. For e.g.:—SMS “678789 CALL” to given mobile number. Alternatively patient can also search available doctors & their DPN in a particular country, city, specialty in smartphone interface and request for the call. All telephonic discussions will be recorded on request/automatically for any future reference for patient or Doctor.

The present invention provides an effective communication system between a doctor and a patient using a smartphone interface, which is highly reliable and involves use of different server engines to perform the operation of communication between the doctor and patient in case of any trivial problem by patient. The system saves doctor's as well as patient's personal time and maintains doctor's privacy in case of any trivial problem without disclosing his or her personal mobile number to the patient.

It is to be understood that both the foregoing general description and the following details description are exemplary and explanatory and are intended to provide further explanation of the invention as claimed.

### BRIEF DESCRIPTION OF THE DRAWINGS

The foregoing and other features of embodiments will become more apparent from the following detailed description of embodiments when read in conjunction with the accompanying drawings. In the drawings, like reference numerals refer to like elements.

FIG. 1 shows a block diagram of the System for establishment of effective communication between a doctor and a patient according to one embodiment of the present invention.

FIG. 2 shows a block diagram of the working of the system to establish effective communication between a doctor and a patient according to one embodiment of the present invention.

FIG. 3 represents other System Business Unit from another country. It explains how patients from different countries registered as customers in this system, how patient would see the doctor's call rates, talk to him, and how payments are being made according to one embodiment of the invention.

FIG. 4 represents a process flow diagram which explains how patient will reach doctor in case of emergency. It basically shows the emergency flow diagram when an emergency call is made by the patient to doctor.

FIG. 5 represents a process flow diagram which explains how patient from one country will reach doctor from another country through DPN and complete the telephone calls including payments through forex rates.

### DETAILED DESCRIPTION OF THE INVENTION

Reference will now be made in detail to the description of the present subject matter, one or more examples of which are shown in figures. Each example is provided to explain the subject matter and not a limitation. Various changes and modifications obvious to one skilled in the art to which the invention pertains are deemed to be within the spirit, scope and contemplation of the invention.

The present invention provides a system (100) which is configured to allow the patient for establishing telephone call with doctor in an effective way and make payments for the call per minute without any difficulty. The system is also configured to allow effective communication between patients of one country and doctor of different country.

The system comprises of a registration engine (102) which allows both the doctor and patient to register their mobile number through smartphone (101) interface. Once the doctor registers his or her mobile number, a DPN is generated which can be shared by them with their patients. Once patients have registered their mobile number along with payment card details they can contact any doctor of their choice just by dialing his or her DPN or by sending a simple SMS to the system from their registered mobile number using SMS Service Engine (107). After a patient requests a call with a doctor and if that doctor is online, the system first makes a call to the doctor and then to the patient or vice-versa or to both simultaneously thereby setting up a telephonic conference between a doctor and a patient using Telephone Conference Call Engine (103). This call is processed by the Call Engine (104) after receiving a call request from a patient, dialing both the doctor and the patient mobile number for setting up of a telephonic conference between them. In case, a patient requests a call with a doctor and if that doctor is offline, then in that condition, the system intimates the doctor about the patient's interest to talk to him or her by way of push notification using Push Notification Engine (106). In case, a request for call to the doctor is made by the patient and if that doctor is busy on a call with another patient, the system waitlists the patient and assigns him or her a token number. During this time, the patient doesn't need to wait online as the system automatically routes the conference call to the waiting patient when his or her turn arises. The doctor can opt to receive or not receive calls from their patients at any given time through the mobile interface or SMS. The system calculates the call duration and charges the patient as per the minute rate of the particular doctor. Hence, doctors are paid as per the time spent by them with a patient on a call. The patients can pay the charge using electronic wallets or through any other Payment Processing Engine (105).

After dialing DPN in mobile interface, and placing request for a call with a particular doctor, patient can attach or click photos of any documents, lab reports, or even a local wound and share with the doctor using the system, and receive necessary prescription or advice from the doctor. Patient can also add one or more person in the call by entering their telephone numbers.

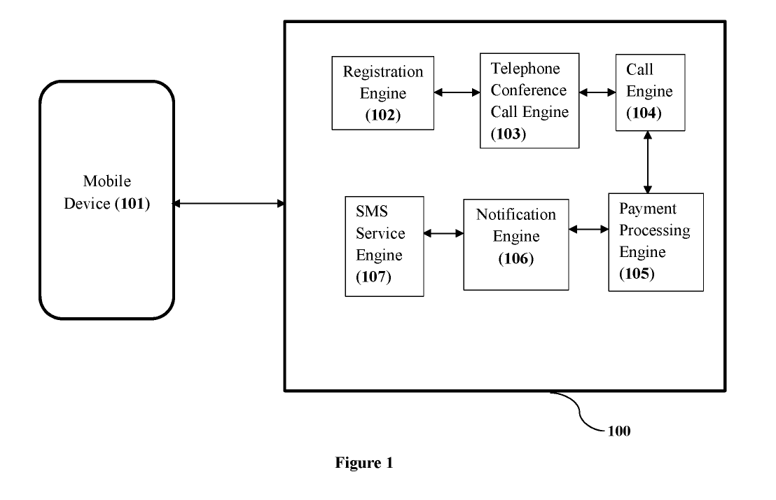

FIG. 1 shows a block diagram of the system (100) providing effective communication occurring between the doctor and the patient, according to one or more embodiments of the present invention. In a preferred embodiment, the block diagram comprises of a smartphone (101) through which the user as well as doctor register their mobile number with the system (100). The registration is done by the patient using Registration Engine (102). The Telephone Conference Call Engine (103) allows the system to set up a telephonic conference call between the doctor and patient by first calling the doctor and then the patient or vice versa or simultaneously. The Call Engine (104) processes the calls through the Telephone Conference Call Engine (103) after receiving a call request from the patient. After the telephonic conversation is being finished between the doctor and patient, the patient is charged for the call per minute basis. So the patient pays the charge using registered digital wallets or any other online payment instrument through Payment Processing Engine (105). If the call is placed to the doctor and the doctor is offline then in that case the doctor will be notified by way of push-notification in the system using Notification Engine (106). A request for call to doctor can be made by the patient by sending SMS to the system using SMS Service Engine (107) from their registered mobile number. In this way communication takes place between the doctor and the patient in an effective manner.

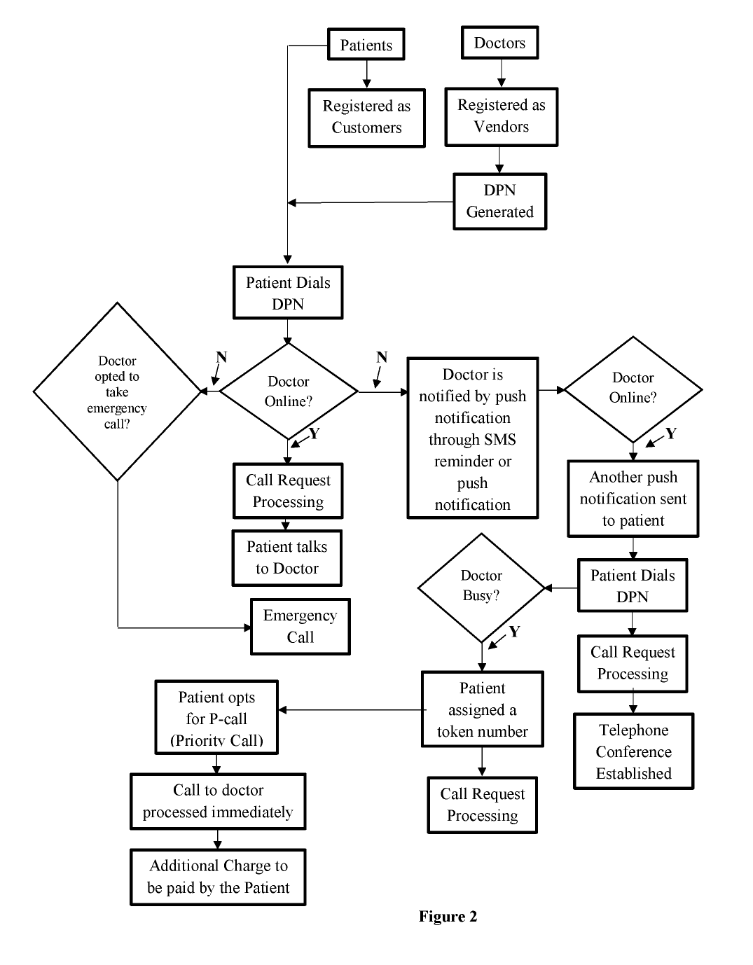

FIG. 2 shows a block diagram of the working of the system in order to establish effective communication between a doctor and a patient. The system mainly involves the process flow to facilitate communication between the doctor and a patient in case of any trivial problem. The system mainly involves registration of the doctor as well as the patient mobile number with the system through mobile interface. Once doctor is registered with his mobile number in the system, he or she gets a DPN which is a number that can be shared with the patients by doctor. It is up to the doctor to opt for receiving calls or not from patients. Doctor also has an option to receive emergency call from the patient even if he or she is offline. If he wishes to receive calls from patient, he can do it by one click “Go Online”. Doctor can also opt for “Go Offline” option if he does not wish to opt for receiving calls from the patient. The patient after registration dials DPN in the mobile interface and place a request to talk to respective doctor. Once doctor's DPN is dialed by the patient, the system will start processing the patient's request to talk to particular doctor. In case the doctor is online after the patient dials his or her DPN, the system will directly start processing the patient's request to talk to particular doctor. But if doctor is offline, the system will intimate the doctor about the patient's interest to talk to him by way of sending “Push Notification” or “SMS Reminder” using Notification Engine (106). After viewing the notification if doctor goes online, another push notification or SMS is sent to patient that doctor is now ready to receive calls and patient may dial DPN to talk and the system will start processing the call request. The system will then set up a private telephone conference between a doctor and a patient by firstly dialing out doctor mobile or telephone number and then dialing out to patients mobile or telephone number or vice-versa or to both simultaneously. The feature of setting up a video conference can also be established between a doctor and a patient by the system for better communication as the scope of the invention is not just restricted to telephonic conference. Suppose doctor is busy with one patient call, system will place other patient in waiting list assigning a token number. Once the other patient call gets over, system will automatically start processing next waiting patient call request. If there is a condition of dire urgency from patient's side, then he or she can opt for priority call (P-Call) with additional fee to by-pass the waiting queue and talk to doctor immediately. During telephone discussion, if the doctor or patient drops off from the conference call because of any mobile network or connectivity issue, the system will again redial and onboard them. After successful call, patient will be charged (auto-debited) as per call duration multiplied with per minute call fee of the particular doctor. Additional service charges will be applicable. The patient can make payment through the payment engine or digital wallet or any other online payment instrument.

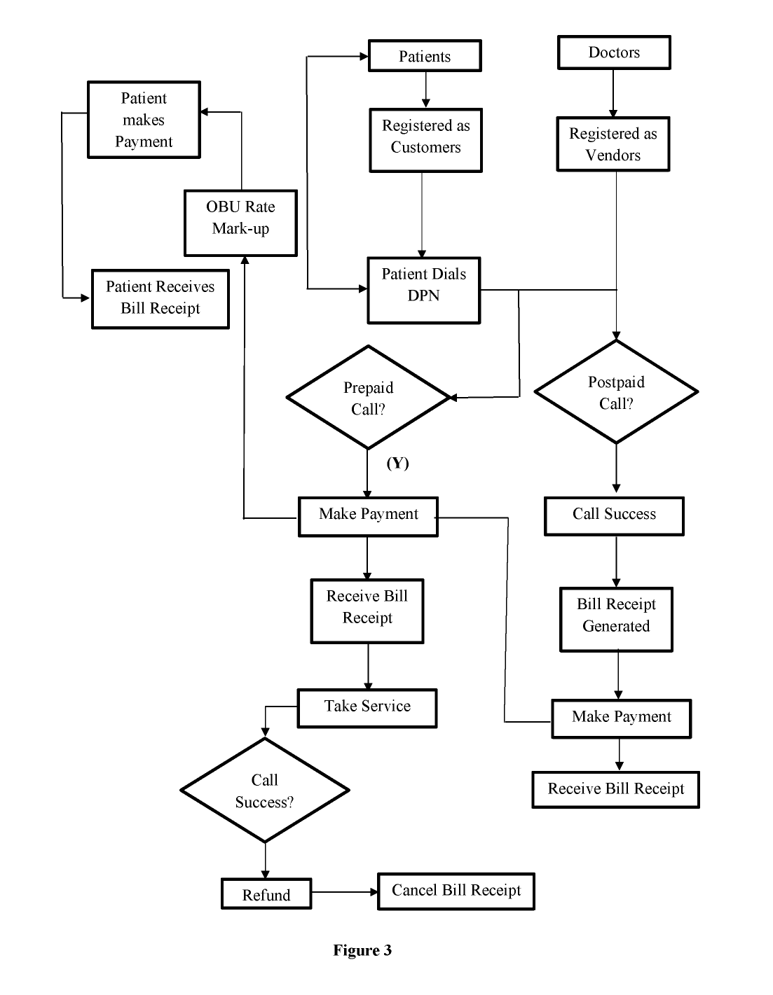

FIG. 3 illustrates the process flow diagram for the registration of the doctor as a vendor and payment made by the patients for the telephonic service provided by doctor. All patients are registered as customers [Registered as Customers] in their respective country's system. Patient can also integrate their digital payment card/wallet [Pt Make Payment] details with the system. “Take service” means talking to any doctor using system. If patient dials DPN of any doctor the call could be pre-paid call or postpaid call as per their digital payment method. For postpaid call, patient would be charged after the call, however for pre-paid patient will be charged a fixed amount for a fixed duration of the call before the call gets initiated. If call was successful, “Call Success” bill receipt will be generated and patient will be charged [Make Payment]. In case of refund request being raised by patient because of call service quality or any other problem, respective bill and doctor earning will be cancelled and money will be refunded [Pt Refund] to the patient.

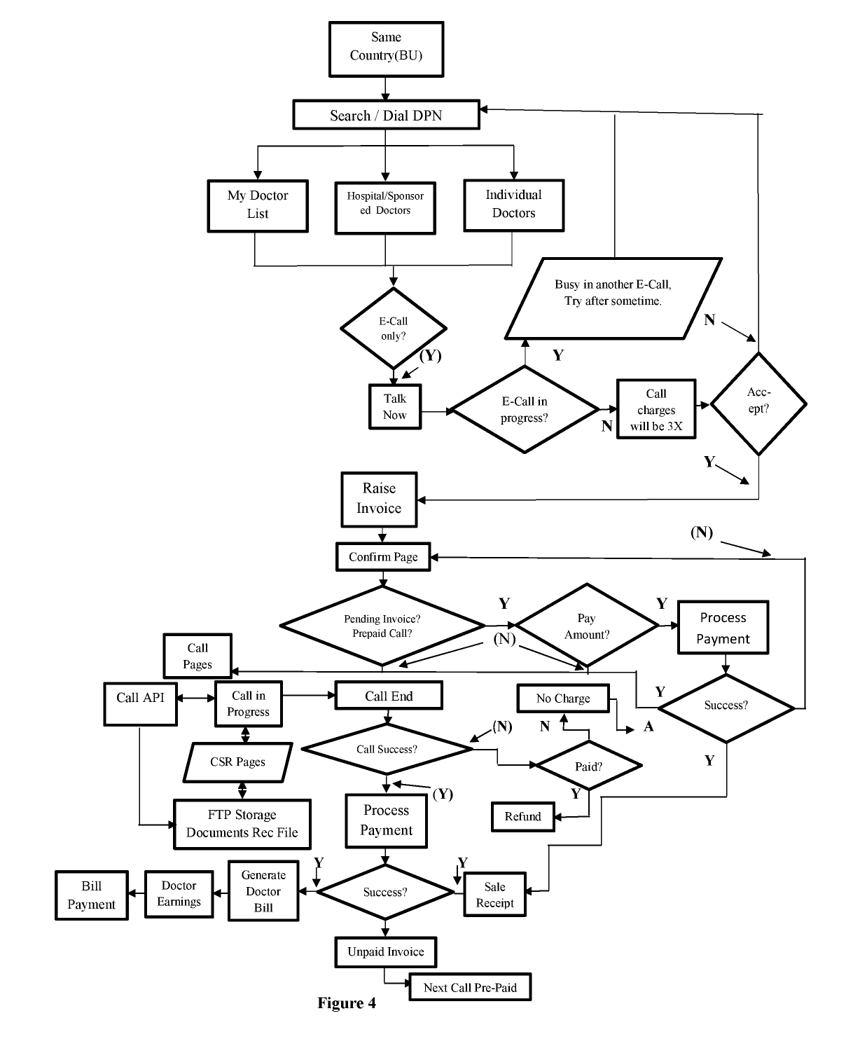

FIG. 4 illustrates the E-Call (emergency call) process flow diagram which explains how patient from Country A will reach doctor of same country (Country A) in case of emergency, according to one embodiment of the invention. In a preferred embodiment, the patient dials DPN of a particular doctor to whom he wishes to talk to. After dialing the DPN, the call service between the doctor and the patient is processed using call engine. If the doctor is online, he or she can directly talk to him by receiving call from the patient else if he or she is offline, then in that case he or she will be notified by way of Push Notification or SMS Reminder through Reminder Manager. Doctors can opt for receiving emergency call from patient, this enables them to receive call from patients even when they are offline at premium additional fee. A Sponsored Doctor List is also provided by the system containing information of list of all Sponsored doctors. These Sponsored doctors are the doctors who take call for free of service if a particular patient is enrolled in any sponsorship program through Promotional codes. This enables patient to talk to any sponsored doctor for free as sponsor will bear the expenses. The sponsors could be Pharma companies, insurance companies, other healthcare institutions and providers etc. A Hospital doctor list is also provided which enables any hospital to place their duty doctors to be available for call with patients when they needed. Patient can search for particular hospital and talk to available doctors. Hospitals may provide 24/7 emergency call service by placing their duty doctors on available for call through system. Once the patient confirms to talk to doctor by accepting doctor charges and agreeing to pay, system will assess whether the call is pre-paid or post-paid. If it is post-paid call the system will take the user to call processing stage or call service page. If the call is pre-paid the system will first process the payment and then take the user to call processing stage or call service page. Before user enters the call processing stage, patient might be placed under waiting with a token number if some other patient(s) are already in queue or talking to doctor. When particular patient qualifies to be connected to the doctor they have requested, the call engine [Call API (Application Programming Interfaces)] from system will make conference call to both doctor and patient and connect them to talk. Further explained points are applicable for all type of calls i.e. Normal call, Emergency call and P-call. During this time “CSR Pages” (Call Service Pages) are opened for doctor and patient. CSR pages include any documents attached by patient for doctor to review, prescription or call notes page for doctor to provide to patients, Bills/receipts, feedback page etc. During the call in progress, system records the call and stores in a secured environment [FTP (File Transfer Protocol) Storage Documents Rec File] for audit based upon patient request for any compliant. The call will get terminated in a fixed duration or if both doctor and patient hang-up. Once the call is over the patient will be charged [Process Payment] as per call duration or time spent by Doctor and respective sales receipts will be provided to patient. Doctor would automatically raise a bill [Generate Doctor bill] to his or her Country's system as his earnings [Doctor Earnings] to be paid. All doctor earnings are collated together for a month or week and paid after tax deduction.

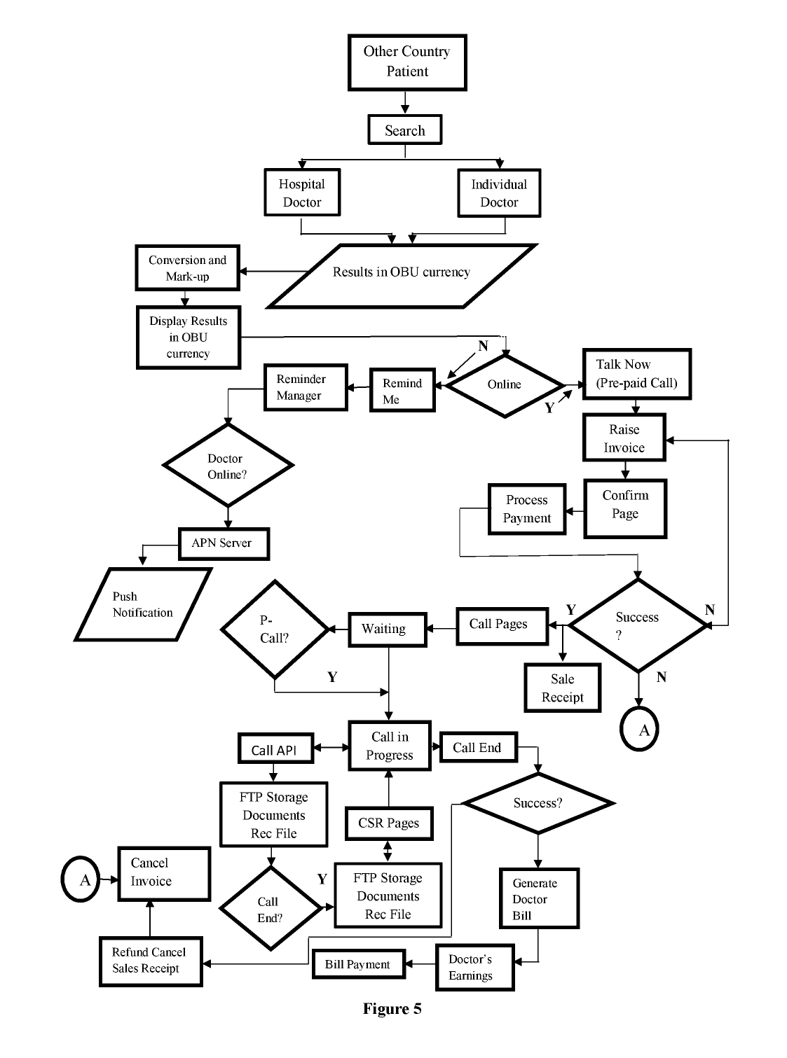

FIG. 5 illustrates the process flow diagram when the patient from Country A dials DPN of a doctor from the Country B (different country). Basically, Country A outsources the Country B doctor's service for its patient. The patient dials the DPN of the doctor to whom he or she wishes to talk. If that particular doctor is online patient can opt for “talk now” or else alert the doctor through push notification or SMS reminder [Reminder manager]. Patient will be notified when the doctor is online. If patient opts for “talk now”, country A (Patient's native country) will setup conference call between country B doctor and country A patient. After successful telephone discussion patient would pay charge to country A's system in their local currency. Country B's system will raise invoice (in OBU currency) in their local currency to country A's system as their doctor (vendor or service provider) provided service to country A patient. Country A will accept the invoice [financial system] and make payment to country B's system in their respective currency [Make Bill Payment as per OBU Bill]. Post receiving payment from country A, Country B will pay [Bill Payment] the amount to their doctor [Doctor Earnings] who provided the service against their bill.

The present invention provides mobile/telephone number privacy to doctor & effective communication system between doctors and patients through mobile or telephone to avoid unnecessary clinical visit and congestions for simple or trivial problems, follow-up reviews, second opinions, counseling sessions etc. This allows critically ill patients to get clinical visit appointments easily. The Doctor's Private Number provide access to patient to reach any doctor across the globe and talk to them in just two clicks or SMS away from their smartphone.

We claim:

1. A system (100) for providing effective communication between a doctor and a patient, the system comprising:
a. a registration engine (102) that allows the patient and the doctor to register with the system using their mobile phone (101);
b. a telephone conference call engine (103) to set up a telephonic call between the doctor and patient;
c. a call engine (104) to process the call between the doctor and patient through the telephone conference call engine (103);
d. a payment processing engine (105) that allows the patient to pay the charge for the telephonic conversation.
e. a notification engine (106) that notifies the doctor about the patient's interest to talk to him or her when he or she is unavailable while a patient requests a call with him.
f. an SMS (Short Message Service) service engine (107) through which the patient can request a call with any doctor across the globe by sending a simple SMS to the system from their registered mobile number.

2. The system as claimed in claim 1, wherein the system (100) generates a DPN (Doctor's Private Number) after the registration completed by the doctor which is a unique number that can be shared by them with their patients for any telephonic discussions.

3. The system as claimed in claim 1, wherein a doctor can opt to receive or not receive calls from their patients at any given time through SMS or smartphone interface.

4. The system as claimed in claim 1, wherein a doctor can determine and set his or her fees for the duration of the calls that they have with their patients.

5. The system as claimed in claim 1, wherein a doctor can also set to receive emergency call from patient for premium fee at any time even they are offline which enables patient to talk to the doctor any time.

6. The system as claimed in claim 2, wherein a patient can search DPN or Doctor in doctors directory and then request a call with any doctor across the globe by dialing the corresponding DPN in their system.

7. The system as claimed in claim 1, wherein the system notifies patient that doctor is online now for discussion if doctor comes online after which patient can request call with doctor or also system can automatically set the call.

8. The system as claimed in claim 1, wherein the system sets up a telephonic conference between the doctor and the patient after a patient requests a call with a doctor.

9. The system as claimed in claim 6, wherein the system dials doctors mobile or telephone number first and then patient's mobile or telephone number or vice-versa or both simultaneously and place them over a conference.

10. The system as claimed in claim 1, wherein the system (100) notifies the doctor about the patient's interest to talk to him or her by way of push notification using notification engine (106) after a patient requests a call with a doctor and if that doctor is offline & not willing to receive call.

11. The system as claimed in claim 10, wherein the system (100) waitlists the patient and assigns him or her a token number after a patient requests a call with a doctor and if that doctor is busy on a call with another patient.

12. The system as claimed in claim 11, wherein the system (100) automatically routes the conference call to the waiting patient when his or her turn arises as the patient don't need to be online while waiting.

13. The system as claimed in claim 12, wherein patients can choose priority call for a extra fee so that they can by-pass the waiting queue and talk to doctor immediately if patient is in dire urgency to talk to doctor.

14. The system as claimed in claim 11, wherein the system (100) automatically redials the doctor and the patient if the doctor or patient drops off from the call because of any mobile network or connectivity issue during telephonic discussion.

15. The system as claimed in claim 1, wherein the conference call is considered as complete if both doctor and patient disconnects the call or after a particular fixed call duration set in the system.

16. The system as claimed in claim 1, wherein the patient can add photos or additional persons in the call.

17. The system as claimed in claim 1, wherein the system (100) estimates the call duration and charges the patient as per the minute rate of the particular doctor.

18. The system as claimed in claim 17, wherein the system (100) automatically deducts the amount from patients payment instruments like digital wallet or credit card and sends the receipt to patient in case of a post-paid call.

19. The system as claimed in claim 17, wherein the system (100) requests patients to make payment for a particular call duration and initiate the conference between doctors and patients in case of a pre-paid call.

20. A method for providing effective communication occurring between the doctor and the patient, the method comprising the steps of:
a) registration of doctors as vendors and patients as customers;
b) receiving of DPN by doctor after registering with the system (100);
c) listing of all the doctors of same or different country after the patient registers with the system (100);
d) patient of same country calling the doctor of same country by searching or dialing the DPN of that doctor from address book or contact list available in patient's website;
e) telephonic conversation happening between the doctor and patient if the doctor is available;
f) conversion of foreign doctors fee in patient's local currency displayed by the system (100); and
g) paying of charge by customer using digital wallets or any other online payment instrument.

21. A method as claimed in claim 20, wherein other business unit of the system in another country is registered as vendor.

22. A method as claimed in claim 21, wherein each system business unit in every country considers other country business unit as a vendor who would provide outsourced services through their doctors.

23. A method as claimed in claim 20, wherein the communication happens between the doctor and patient of different countries comprising steps of:
a) listing of all doctors under their respective country and making it available to all patients from any country;
b) dialing DPN of the doctor from another country by the patient of different country and see his or her rates in their local currency after appropriate forex conversion carried by the system (100);
c) raising of bills by that doctor to their respective system as per their time spend on the call;
d) charge imposed by system on the patient to be paid in local currency as per forex exchange rates; and
e) raising of invoices by doctor country's system to patient country's system (100) as outsourced service.
